(19) United States
(12) Patent Application Publication
(10) Pub. No.: US 2012/0192733 A1
(43) Pub. Date: Aug. 2, 2012

(54) SYSTEM AND METHODS FOR PRINTING, EMBOSSING AND CUTTING

(76) Inventor: Faye Angevine, Taipei (TW)

(21) Appl. No.: 13/359,836

(22) Filed: Jan. 27, 2012

Related U.S. Application Data
(60) Provisional application No. 61/437,256, filed on Jan. 28, 2011.

(51) Int. Cl. B41F 19/02

(52) U.S. Cl. 101/26

(57) ABSTRACT

Hand operated hinged folder assembly for printing, embossing and cutting includes a base member with a recessed well for placement of stamps, embossing elements or die cutters therein and a lid hingedly attached to the base member for engaging with the base member having a recessed well for receiving a various inserts including a cutting mat, a stamping surface or embossing elements. The hinged folder is configured to be passed through a roller press to cause the hinged folder to stamp, emboss or cut a sheet of paper placed within the hinged folder.

### CROSS-REFERENCE TO RELATED APPLICATION

The present application claims priority to U.S. Provisional Patent Application Ser. No. 61/437,256 filed on Jan. 28, 2011, the entirety of which is incorporated by this reference.

### BACKGROUND

1. Field of the Invention

The present invention relates systems and methods for printing, embossing and cutting with reusable inked stamps, embossing dies and cutting dies. More specifically, the present invention relates to systems and method for printing, embossing and cutting with reusable ink stamps, embossing dies where a plurality of such stamps and dies can be combined to simultaneously form one or more images on a single sheet of paper.

2. Description of the Related Art

Hobby craft projects, such as creating scrapbook pages or handmade greeting cards often involve the use of hand-placed reusable ink stamps, embossing dies and/or cutting dies. Reusable ink stamps typically have a base of a harder material, such as wood or plastic and a compressible inkable image portion, typically formed from a rubber pad. Embossing devices are typically formed of a positive die portion and a corresponding negative die portion with the positive and negative die portions being brought together under compression to cause embossing of a sheet of paper inserted between the embossing dies. Cutting dies are typically formed of a base having a cutting blade in the shape of a dosed image. When a cutting die is pressed against a sheet of paper, the butting blade curs through the sheet of paper to form a die cut of the image.

Most ink stamping is performed by hand. In such ink stamping applications, when multiple stamps are used on the same sheet of paper, it is often difficult for a user to obtain the desired alignment between stamps, or to ensure that a consistent application of pressure to each stamp is obtained so as to maintain consistency in appearance between each stamped image. For example, in order for a user to create a custom stamped word that is not provided in a single stamp, the user would necessarily use a plurality of stamps with each individual stamp having a raised character of a letter in the word. Each letter in the word would be applied to the paper by inking the stamp and pressing the stamp to the paper. Because of this individual process, each letter may be inked with a different quantity of ink with more ink creating a darker letter and less ink creating a lighter letter. In addition, because it is virtually impossible to apply the exact same amount of pressure as each successive stamp is pressed against the paper, the letters may also appear lighter or darker depending on the pressure applied to the stamp. Finally, it is quite difficult to properly align adjacent characters in the word since the user must simply eyeball the location of the next stamp relative to the paper. In all such instances, once the stamp is pressed against the paper and an inked image of the letter is formed, it is virtually impossible to correct any mistakes. Even in instances where a slightly darker image is desired, attempts to re-stamp a previously stamped letter in the same location will usually result in a slightly offset imprint of the letter since it is very difficult to precisely realign the stamp to the exact position of the previous stamp.

Roller-type presses in the craft industry were first developed for use with die cutters. A die cut block is comprised of a base of wood or plastic from which a metal cutting blade extended, with the contour of the cutting blade defining a particular closed shape, such as a letter or design element. In order to cut a sheet of paper using such a the cutter, a sheet of paper is placed on a cutting mat (typically formed of a semi-rigid plastic), the die cutter is then placed with its blade against the paper. The mat, paper and die cutter are then feed through a roller-type die press, which may be manually or electronically driven. The roller-type die press includes at least two opposing rollers that are at a set distance apart. As the mat, paper and die cutter pass between the rollers, the blade of the die cutter is pressed through the paper and into the mat, causing the paper to be cut into the shape of the blade.

One particular type of die cutter is formed by a process of chemical etching. The resulting dies, commonly referred to as “CEDs”, are formed from a single sheer of metal that has one side that has been chemically etched to form one or more blades that extend from the surface of the CED after etching in the shape of one or more design elements. Chemically etched dies are typically thinner than traditional die cutting blocks, but, as a result, are typically only capable of cutting one or two sheets of paper, depending on paper thickness. Again, roller-type die presses are commonly used to cause a CED to cut through a sheet of paper in a manner similar to that described with reference to die cutting blocks.

As for embossing techniques in the craft industry today, there are various methods used to create embossed images in paper. One of the more popular methods of embossing uses what is commonly referred to as an embossing folder. Embossing folders are formed from a plastic sheet that is folded along a living hinge. A positive relief of an image is formed on one half of the embossing folder and a matching negative relief of the image is formed on the other half of the embossing folder. The positive and negative reliefs are brought together with a sheet of paper inserted between and compressed, as by running the embossing folder and paper through a press, such as a die press, to cause the sheet of paper to be embossed by the engagement of the positive and negative reliefs. Each embossing folder typically contains a particular design, such as a word, phrase or design element. Using such embossing folders, it would be very difficult, if not impossible, to create a plurality of embossed images using various embossing folders on a single sheet of paper.

Thus, there exists a need in the art that will allow a sheet of paper to be simultaneously printed, embossed or cut using a plurality of stamps, embossing elements or die cutters in an arrangement determined by the user. There also exists a need in the art of a system that enables the alignment of multiple reusable, hand-placed stamps or embossing elements for simultaneously stamping or embossing a single sheet of paper with the multiple stamps or embossing elements. There also exists a need in the art to provide a system art that will allow a sheet of paper to be simultaneously printed, embossed or cut using a plurality of stamps, embossing elements or die cutters in an arrangement determined by the user that is easy to use, is easy to manufacture and that can be used with existing roller-type press technologies.

### SUMMARY OF THE INVENTION

The present invention is directed to systems and methods for printing, embossing and cutting. In one illustrative embodiment, a system in accordance with the present invention includes a base portion which may have a recessed well for placement of stamps, embossing elements or die cutters. A removable lid is placed over the base. A sheet of paper between the base and the lid so that when pressure is applied to the lid, the stamps will apply ink to the paper, the embossing elements will engage to emboss the paper or the die cutters will cut through the paper to form die cuts.

In one embodiment, a roller assembly is provided for passing over the lid to cause the lid to be pressed toward the base.

In another embodiment, the base is provided with elongate tracks along the sides thereof and a roller assembly is removably connected to the tracks to compress the lid with roller component of the roller assembly. As the roller assembly is moved along the tracks across the top surface of the lid, the stamp, embossing element or die cutter is pressed against a sheet of paper.

In another embodiment, the base and lid are hinged together. The profile of the hinges is equal to or less than the overall height of the base and lid when engaged. A roller machine is provided through which the base and lid, with a sheet of paper disposed there between can pass, causing the stamp, embossing element or die cutter to be pressed against the sheet of paper.

In yet another embodiment, the base and/or lid is provided with a recess within which a slotted board is inserted. The slotted board provides recesses to which a plurality of embossing elements, cutters and or stamps can be temporarily secured so as to hold them in place during the pressing process. The slotted board is configured to align adjacent embossing elements, cutters and/or stamps.

In some embodiments, a removable mat may to used to line the recessed well of the base to facilitate stamping or cutting.

### BRIEF DESCRIPTION OF THE DRAWINGS

It will be appreciated by those of ordinary skill in the art that the various drawings are for illustrative purposes only. The nature of the present invention, as well as other embodiments of the present invention, may be more clearly understood by reference to the following detailed description of the invention, to the appended claims, and to the several drawings. Elements and acts in the figures are illustrated for simplicity and have not necessarily been rendered according to any particular sequence or embodiment.

FIG. 1A is a top view of a printing, embossing and cutting system in accordance with one aspect of the present invention.

FIG. 1B is a top view of the printing, embossing and cutting system of FIG. 1 in a disassembled state.

FIG. 10 is a top view of the base portion of the system of FIG. 1B.

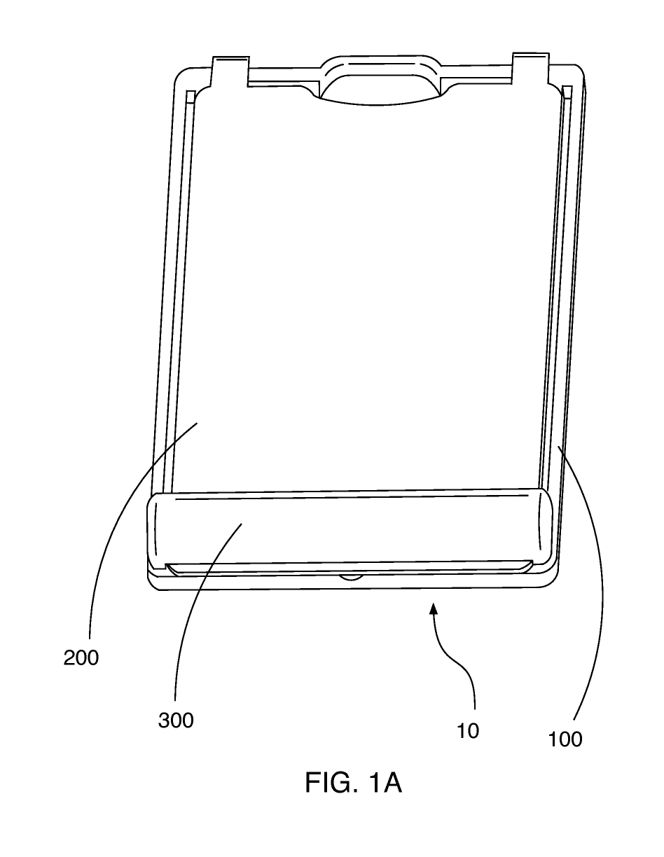

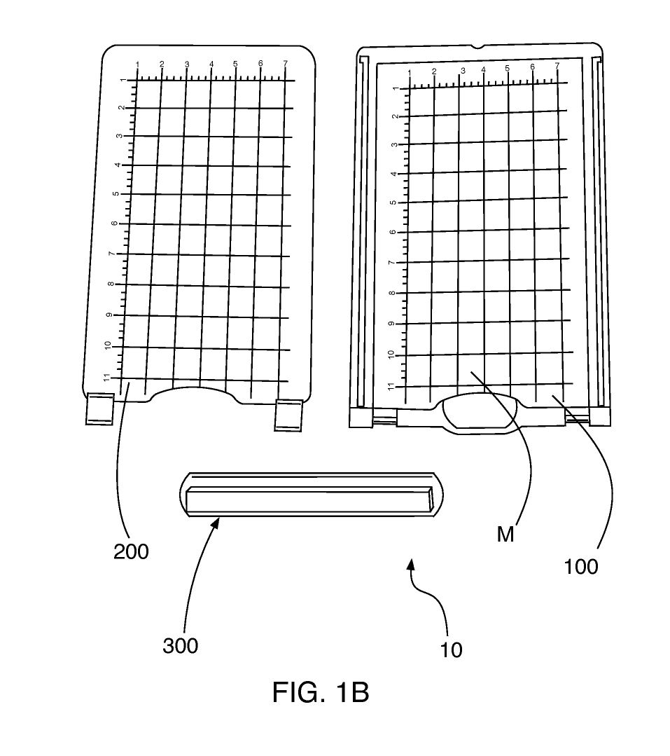

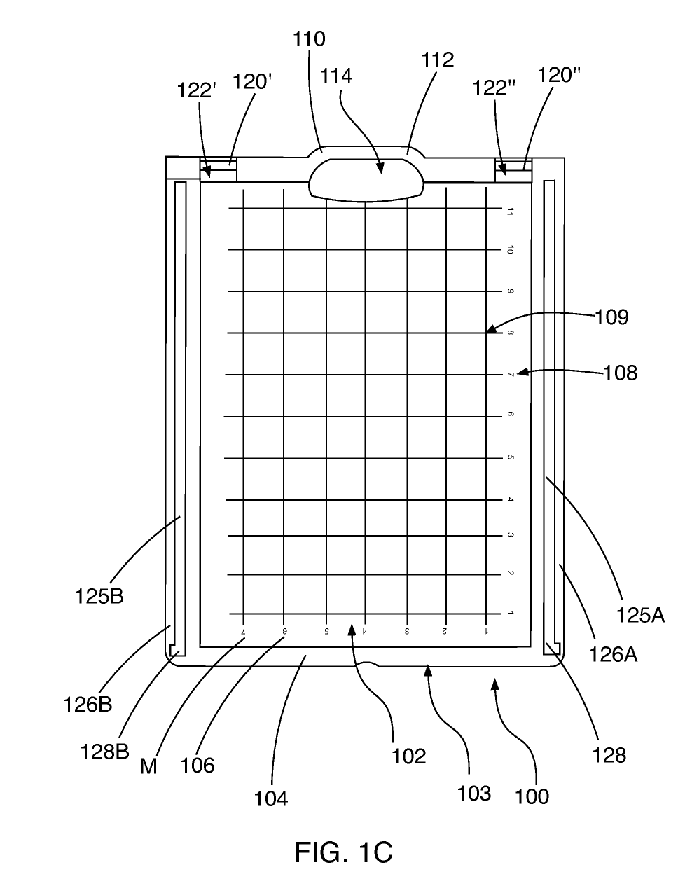

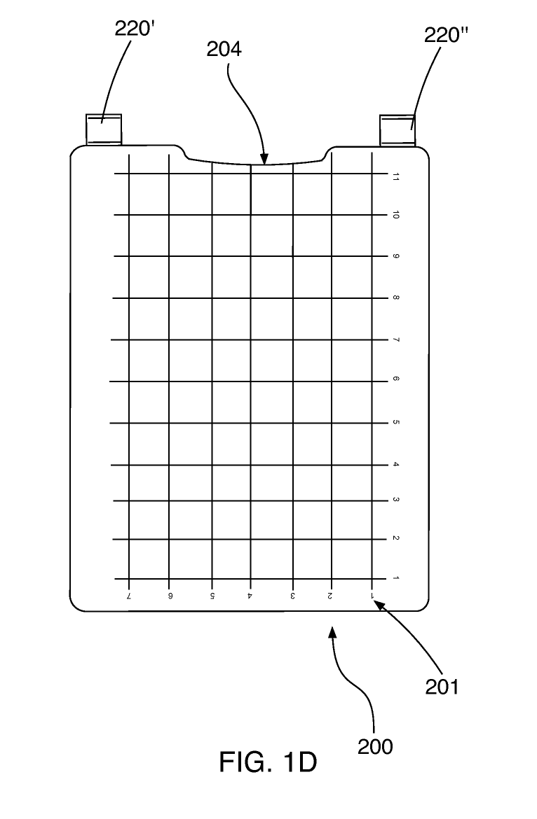

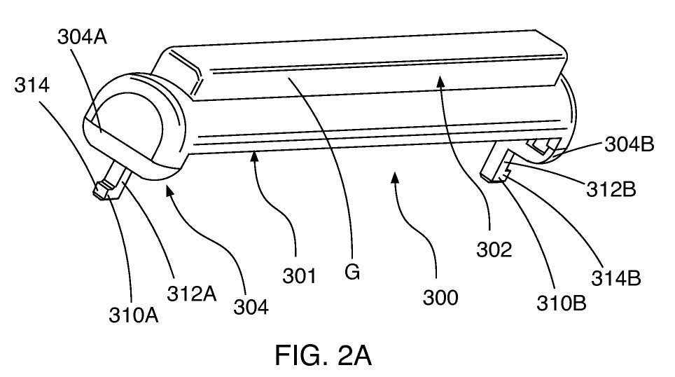

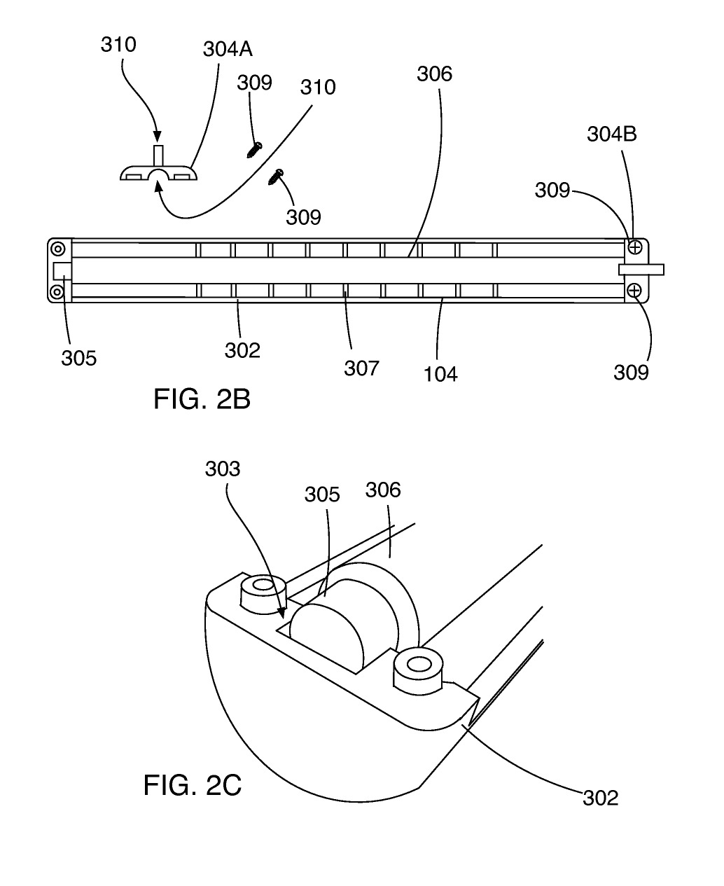

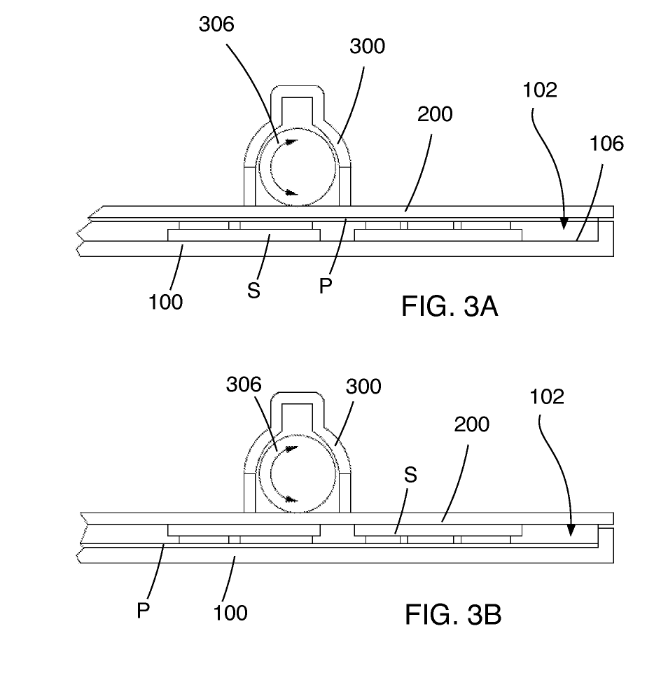

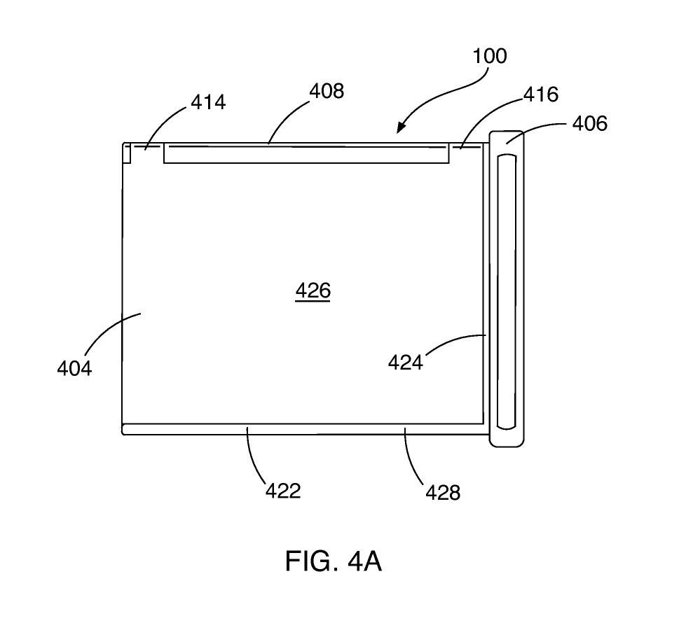

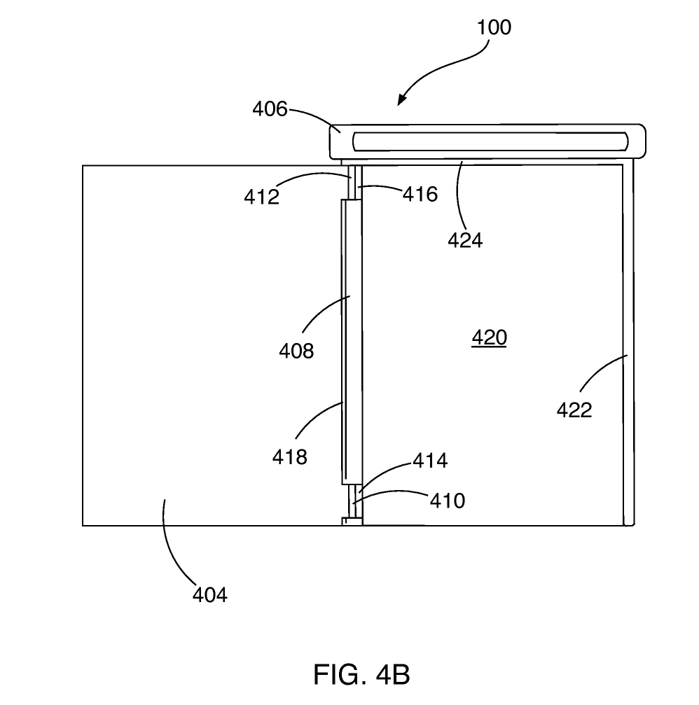

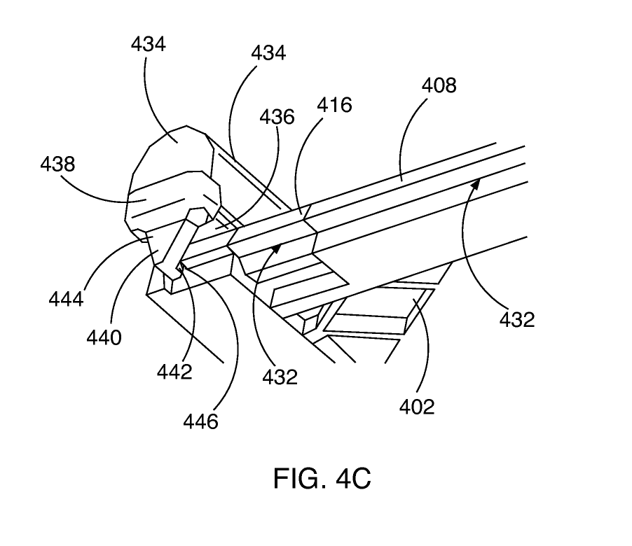

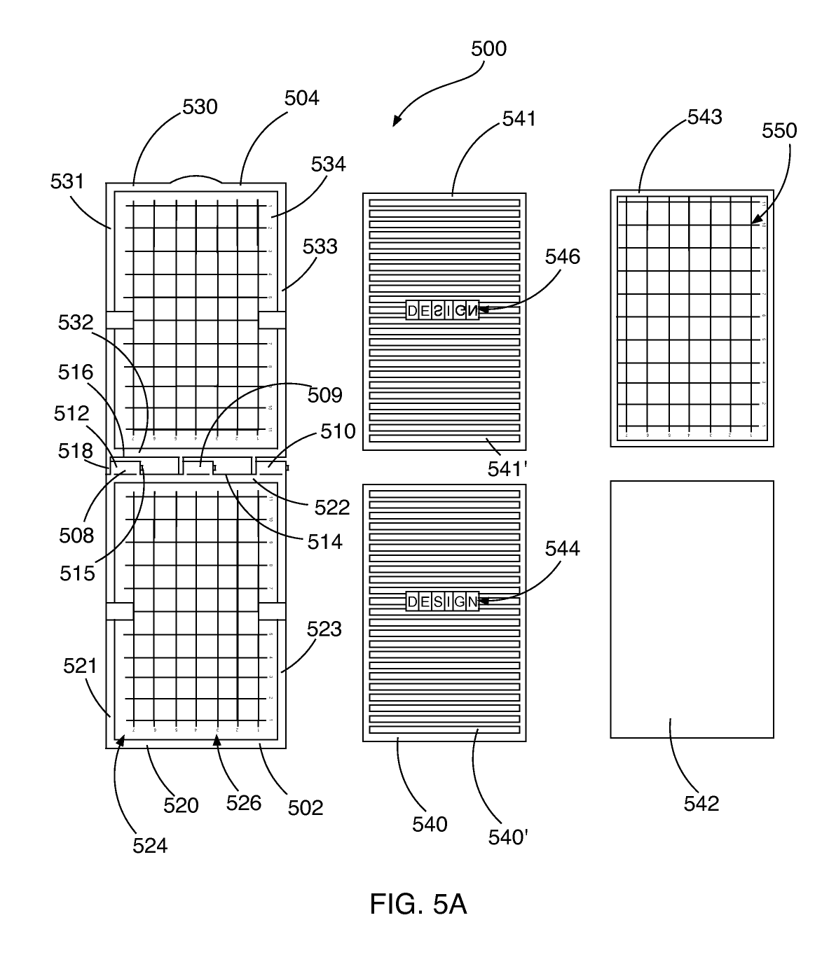

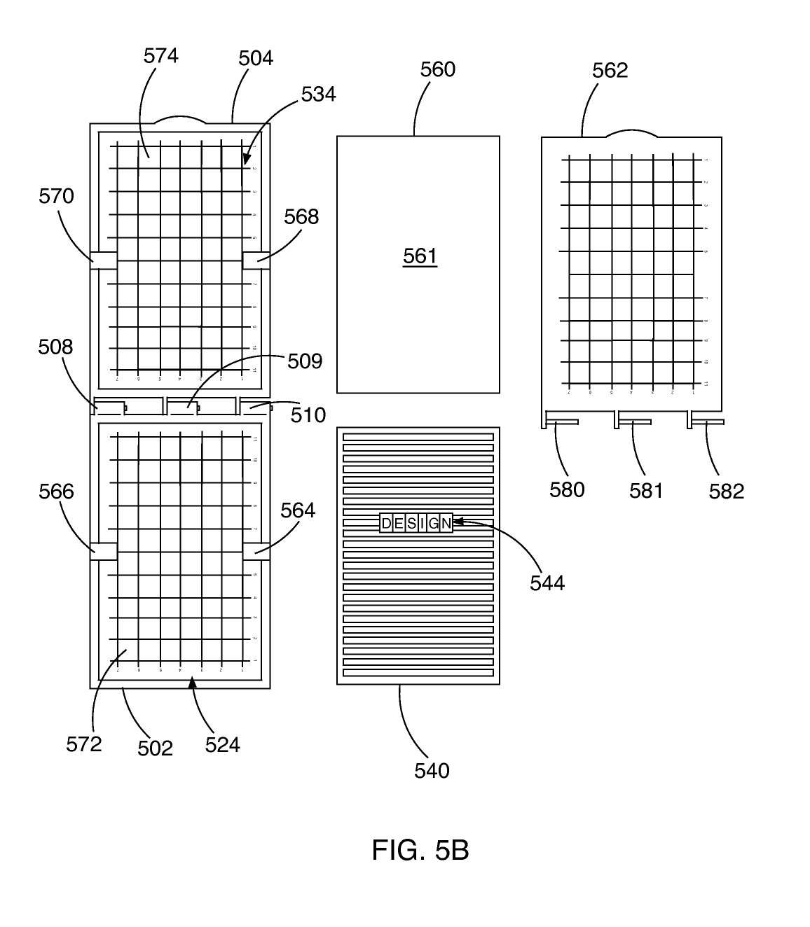

FIG. 1D is a top view of the lid portion of the system of FIG. 1B.

FIGS. 2A, 2B and 2C are perspective side and bottom views of the roller component of the system of FIG. 1B.

FIGS. 3A and 3B are cross-sectional side views of a portion of a printing, embossing and cutting system in accordance with the present invention in use.

FIGS. 4A, 4B and 4C are top and bottom perspective views of an alternative embodiment of a printing, embossing and cutting system in accordance with one aspect of the present invention.

FIG. 5A is a top view of yet another embodiment of a printing, embossing and cutting system in accordance with one aspect of the present invention with various attachments.

FIG. 5B is a top view of the printing, embossing and cutting system illustrated in FIG. 5A with various other attachments.

FIG. 6A includes top and side views of a first embodiment of an embossing set in accordance with the principles of the present invention.

FIG. 6B includes top perspective views of a second embodiment of an embossing set in accordance with the principles of the present invention.

FIG. 7 is cross-sectional side view of another embodiment of a printing, embossing and cutting system in accordance with the present invention in use.

FIGS. 8A, 8B and 8C are cross-sectional side views of yet another embodiment of a printing, embossing and cutting system in accordance with the present invention in use.

FIG. 9 is cross-sectional side view of another embodiment of a printing, embossing and cutting system in accordance with the present invention in use.

### DETAILED DESCRIPTION OF THE ILLUSTRATED EMBODIMENTS

The present invention relates to systems and methods for printing with reusable ink stamps. It will be appreciated by those skilled in the art that the embodiments herein described, while illustrating certain embodiments, are not intended to so limit the invention or the scope of the appended claims. Those skilled in the art will also understand that various combinations or modifications of the embodiments presented herein can be made without departing from the scope of the invention. All such alternate embodiments are within the scope of the present invention.

Aspects and applications of the invention presented here are described below in the drawings and detailed description of the invention. Unless specifically noted, it is intended that the words and phrases in the specification and the claims be given their plain, ordinary, and accustomed meaning to those of ordinary skill in the applicable arts. It is noted that the inventor can be his own lexicographer. The inventor expressly elects, as his own lexicographer, to use only the plain and ordinary meaning of terms in the specification and claims unless they clearly state otherwise and then further, expressly set forth the “special” definition of that term and explain how it differs from the plain and ordinary meaning. Absent such clear statements of intent to apply a “special” definition, it is the inventor's intent and desire that the simple, plain and ordinary meaning to the terms be applied to the interpretation of the specification and claims.

The inventor is also aware of the normal precepts of English grammar. Thus, if a noun, term, or phrase is intended to be further characterized, specified or narrowed in some way, then such noun, term, or phrase will expressly include additional adjectives, descriptive terms, or other modifiers in accordance with the normal precepts of English grammar. Absent the use of such adjectives, descriptive terms, or modifiers, it is the intent that such nouns, terms, or phrases be given their plain, and ordinary English meaning to those skilled in the applicable arts as set forth above.

Further, the inventor is fully informed of the standards and application of the special provisions of 35 U.S.C. §112, ¶ 6. Thus, the use of the words “function,” “means” or “step” in the Detailed Description of the Invention or claims is not intended to somehow indicate a desire to invoke the special provisions of 35 U.S.C. §112, ¶ 6, to define the invention. To the contrary, if the provisions of 35 U.S.C. §112, ¶ 6 are sought to be invoked to define the inventions, the claims will specifically and expressly state the exact phrases “means for” or “step for” and the specific function (e.g., “means for filtering”), without also reciting in such phrases any structure, material or act in support of the function. Thus, even when the claims recite a “means for . . . ” or “step for . . . ” if the claims also recite any structure, material or acts in support of that means or step, or that perform the recited function, then it is the clear intention of the inventor not to invoke the provisions of 35 U.S.C. §112, ¶ 6. Moreover, even if the provisions of 35 U.S.C. §112, ¶ 6 are invoked to define the claimed inventions, it is intended that the inventions not be limited only to the specific structure, material or acts that are described in the illustrated embodiments, but in addition, include any and all structures, materials or acts that perform the claimed function as described in alternative embodiments or forms of the invention, or that are well known present or later-developed, equivalent structures, material or acts for performing the claimed function.

In the following description, and for the purposes of explanation, numerous specific details are set forth in order to provide a thorough understanding of the various aspects of the invention. It will be understood, however, by those skilled in the relevant arts, that the present invention may be practiced without these specific details. In other instances, known structures and devices are shown or discussed more generally in order to avoid obscuring the invention. In many cases, a description of the operation is sufficient to enable one to implement the various forms of the invention, particularly when the operation is to be implemented in software. R should be noted that there are many different and alternative configurations, devices and technologies to which the disclosed inventions may be applied. The full scope of the inventions is not limited to the examples that are described below.

Various aspects of the present invention may be described in terms of functional block components and various processing steps. Such functional blocks may be realized by any number of hardware or software components configured to perform the specified functions and achieve the various results.

Referring to FIGS. 1A and 1B, there is illustrated a first embodiment of printing, embossing and cutting board system 10, in accordance with the principles of the present invention. As depicted, system 10 includes a base portion 100, a lid portion 200, and a roller assembly 300.

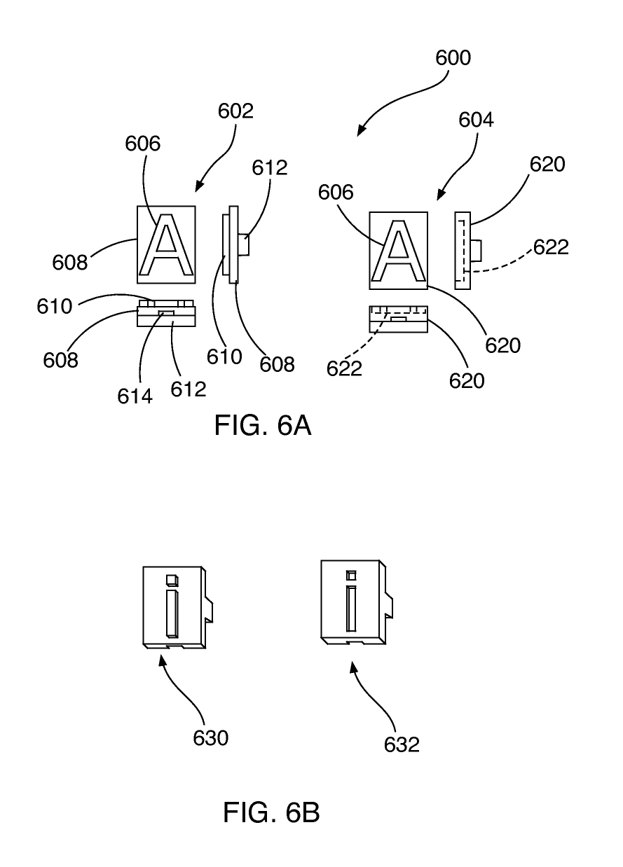

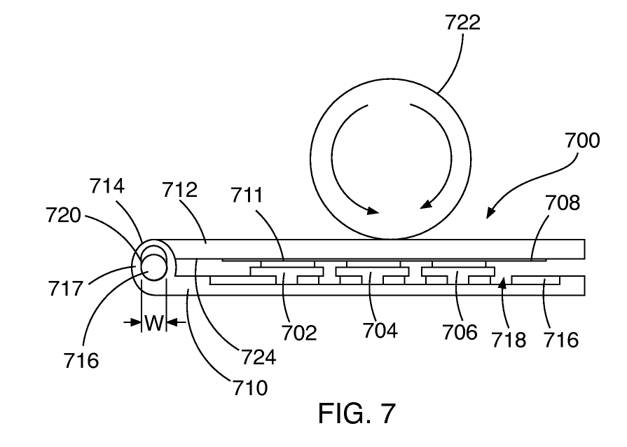

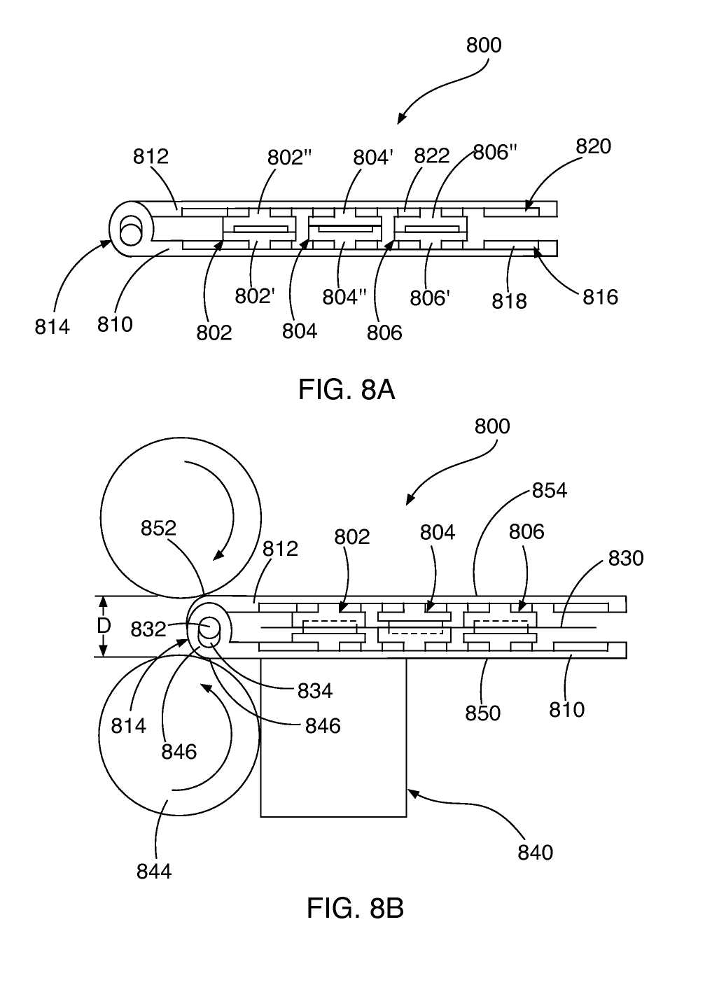

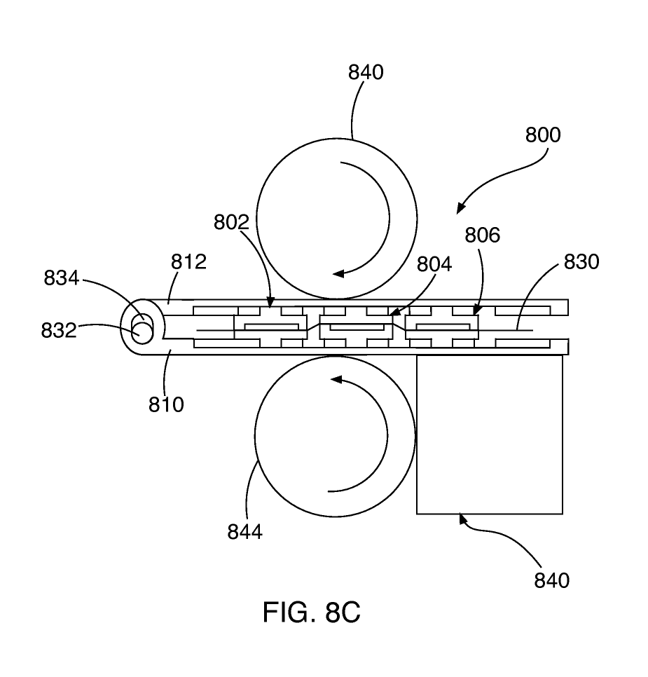

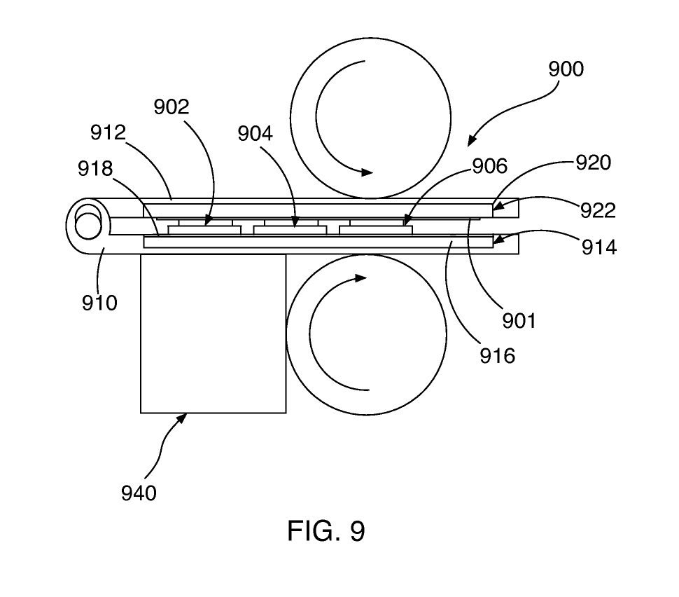

Base portion 100, best depicted in FIG. 10, may be a generally planar member with a generally rectangular shape. The upper surface of the base 100 includes a recessed well 102 which is surrounded by an encircling sidewall 104. The floor or bottom surface 106 of the recessed well 102 is generally planar. As the area of the recessed well 102 acts to define the size of a media (such as a sheet of paper) that may be printed with system 10, base 100, and system 10 may be sized to receive a media of a standard paper size, such as A4 or letter-sized paper, or may have smaller area intended for use with card stock.

Recessed well 102 may includes additional features to facilitate use in stamping paper and other sheet materials. For example, length-marking indicia 108 may be disposed in the recessed well 102. In the depicted embodiment, such indicia are formed by the application of a colored material to the floor of the recessed well, such as a paint or dye or physically or molded, etched or engraved into the base 100. As depicted, the indicia may be placed both longitudinally and transversely to create a set of markings that form a grid pattern 109. As depicted, these markings may reflect inches and parts thereof, or may be any desired units. It will be appreciated that for certain embodiments, the paint or dye may be selected to have non-slip properties, such as a relatively high coefficient for friction compared to the body of the base 100, in order to reduce the likelihood of slipping during use.

At a first end 110 of the base 100, a handle 112 may be formed as an extension of the base 100, which passes outwards from the remainder of base 100 to define an aperture 114 extending through base 100. As depicted, the handle aperture 114 may be partially disposed in the recessed well 102.

On either side of handle 112 a pivot point for the removable attachment of lid 20 may be disposed. In the depicted embodiment, the pivot points are hinge axles 120 formed as rounded members passing across a recess 122 in the sidewall 104 of the base member 100. It will be appreciated that each hinge axles 120′ and 120″ may be formed as an extension of the sidewall 104.

On either side of recessed well 102, a track may be longitudinally disposed on the side wall 104. In the depicted embodiment, each track is a slot 125A and 125B formed in the sidewall 104 parallel to the long axis of the base member 100. Along the side of recessed well 102, each track 125A and 125B includes a retaining structure 126A and 1268 formed as an extension of the sidewall 104 upper surface that extends from the outer portion of the sidewall towards the recessed well 102 to form an overhang giving the slot 125 a generally L-shaped-cross-sectional shape through this portion. At the end of each slot 125A and 125B nearest second end 103 of the base 100, the retaining structures 126A and 126B are absent, to provide insertion ports 128A and 1288 for the counterpart structure on roller assembly 300, as will be discussed in further detail herein.

Base 100 may be constructed from any suitable material, including injection molded plastics, such as ABS, PVC and the like.

The lid portion 200, best depicted in FIG. 1D, may be a generally planar member with a generally rectangular shape having opposite planar upper and lower surface. In some embodiments, lid 200 may be formed from translucent or transparent materials, such a polycarbonate, to allow a user to view stamps or sheet materials therethrough during use.

The lid 200 may include additional features to facilitate use in stamping paper and other sheet materials. For example, length marking indicia 201 may be disposed on the lid 200 and may correspond to the similar indicia in the recessed well 102 of base 100. In the depicted embodiment, such indicia may be formed by the application of a colored material, such as a paint or dye, to either the upper or lower surface of the lid or physically molded, etched or engraved into the lid. As depicted, the indicia may be placed both longitudinally and transversely to create a set of markings that form a grid pattern. As depicted, these markings may reflect inches and parts thereof, or may be any desired units. It will be appreciated that for certain embodiments, the paint or dye may be selected to have non-slip properties, such as a relatively high coefficient for friction compared to the body of lid 200, in order to reduce the likelihood of slipping during use.

Lid 200 is sized to cover recessed well 102 of the base 100 upon removable attachment thereto, lying on the upper surface of the encircling sidewall 104 and within the slot 125A and 125B. At a connection end, 204, lid 200 may be shaped to correspond to handle recess 114, allowing use of handle 112 with the lid 200 installed on base 100. Hinge tabs 220′ and 220″ extend outward from the lid body parallel to one another and may include a curved portion to facilitate rotation. In use, each hinge tab 220′ and 220″ is inserted into a recess 122′ and 122″, respectively, corresponding to a hinge axle 120 and pivots by rotational movement around the hinge axle 120.

It will be appreciated that although two hinge structures are depicted and described that any desired number may be used, such as three or four hinge tabs 220′ and 220″ and corresponding hinge axles 120′ and 120″, as may be advantageous for various uses.

Roller assembly 300, depicted in FIGS. 2A, 2B and 2C, includes a cover 301 formed of an upper handle component 302, which may be formed as a body having an upper surface with a handle portion G for operation. In the depicted embodiment, the upper handle component 302 has a curved upper surface with a handle G formed as a bar on the apex of the curve. At either end, an attachment component 304 is connected to the lower surface of the handle component 302 to complete the cover 301.

FIG. 2B shows a roller assembly 300 with one attachment component 304A removed therefrom, in order to illustrate certain features. On the underside of upper handle component 302, the roller 306 is disposed, protruding below the lower surface of the upper handle component 302. As depicted, the roller 306 may be an elongated cylinder with a circular cross-sectional shape extending across the length of the upper handle component 302. At either end, the roller may include an end portion 305 where the cylinder steps down to a smaller diameter 305. A plurality of ribs 307, each of which define a semicircular recess for receiving the roller 306 provide structural strength to the handle component 302 and also provide mid support during pressing for the roller 306 as the roller 306 is rotated relative to the handle component 302.

As best depicted in FIG. 2C, the end portion 305 may reside in a corresponding recess 303 that may be formed as a half circle in the end of the upper handle component 302. Attachment component 304A may attach to the upper handle component 302 aligned with the end thereof and over a corresponding recess 311 that may be formed as a half circle therein aligns with the end portion 305 of roller 306 and recess 303 to retain the roller 306 in the roller assembly 300 (FIG. 4B). The attachment component 304A may be attached by screws 309 as depicted or as otherwise known to those of skill in the art.

Each attachment component 304A and 304B includes a lower attachment hook generally indicated at 310A and 310B. Each attachment hook 310A and 310B may include a generally vertically extending shaft 312A and 312B at the distal end of which a connection member 314A and 314B may extend laterally outwards. In use, each attachment hook 310A and 310B is inserted into the corresponding insertion port 128A and 128B in base 100. As the roller assembly 300 is slidably moved, the attachment hooks 310A and 310B slidably moves in respective slots 125A and 125B with shaft 312A and 312 B extending upwards from the base 100 and connection member 314 retained in the slot 125A and 125B by retaining structure 126A and 126B. The length of shaft 312A and 3128 thus determines distance between an installed lid 200 and roller 306, and thus the pressure placed on the components of the system 10 during use.

The roller 306 may be constructed of a suitable material to provide rolling compression, including metals such as steel, aluminum, or other alloys. The upper handle component 302 and attachment components 304 may be constructed from any suitable material, including injected molded plastics, such as ABS.

In some embodiments, a mat M (depicted in FIG. 1B) may be provided that is sized to fit on the floor of the recessed well of base 100. The mat may be formed from a clear or translucent plastic (such as polycarbonate), and may be flexible or rigid as to better allow for ease of use in different applications. Where present, the mat may include a grid similar to the lid 200 and recessed well in order to facilitate the layout of stamps.

In one aspect of use involving such a mat, the stamps are laid out on the mat and attached thereto with a removable adhesive, such as adhesive dots, with the inkable image portions facing upwards. On other embodiments, the mat maybe formed of a material that the stamps releasably adhere to without an adhesive, such as a silicone material. Ink is then applied the raised designs of the stamps, using a roller and a water based ink, that may be relatively thick in consistency. The mat is placed inside the recessed well 102 of base 100 prior to, or after, applying ink.

As illustrated in FIGS. 3A and 3B, the paper or other sheet material is attached, as by removable adhesive dots, to the lower surface of lid 200, using the grid thereon to align to the stamps as arranged in the recessed well 102. The lid 200 is then placed over the base 100, and the roller assembly 300 is connected to base 100 by inserting the attachment hooks 310 in slots 125. Roller assembly 300 is then moved forward and back, rolling the roller 306 across the lid 200 and pressing the stamps against the sheet material. The roller assembly 300 is then removed and the lid 200 raised to remove the sheet material with the printed design thereon.

In a second aspect of use that does not include the mat, the lid 200 is removed from base 100 and a stamp layout designed by placing stamps S in the recessed well 102, inking the stamps before or after placement. Where desirable, the stamps S may be releasably adhered to the floor 106 of the recessed well 102 to maintain the desired layout. For example, a releasable adhesive may be disposed thereon, or in certain embodiments the base 100 may contain a metal sheet, such as a steel insert, or be made of a suitable metal and the stamps S may contain magnets to magnetically adhere thereto. The sheet material P is placed on the base 100 over the stamps S, the lid 200 is then slotted into the base and the hinges closed to place the sheet material P under the lid 200. As depicted in FIG. 3A, the roller assembly 300 is then moved forward and back, rolling the roller 306 across the lid 200 and pressing the stamps against the sheet material P. The roller assembly 300 is then removed and the lid 200 raised to remove the sheet material with the printed design thereon.

In another aspect of use that does not include the mat as shown in FIG. 3B, the lid 200 is removed from base 100 and the sheet material placed in the recessed well 102 directly on the floor thereof. The stamp layout may be formed by adhering the stamps S to the lid 200. Where lid 200 has a grid patter formed thereon, it may be used to align the stamps S in a desired layout. Stamps S may be adhered with a releasable adhesive compatible with the stamp S base material and the I′d 200 material. In certain embodiments, the lid 200 may contain a metal sheet, such as a steel insert, or be made of a suitable metal and the stamps S may contain magnets to magnetically adhere thereto. The lid 200 is then closed and the adhered stamps S thereby lowered into recessed well 102 over the sheet material P. The lid 200 is then slotted into the base and the hinges closed. As depicted in FIG. 5B, the roller assembly 300 is then moved forward and back, rolling the roller 306 across the lid 200 and pressing the stamps against the sheet material P. The roller assembly 300 is then removed and the lid 200 is raised.

FIGS. 4A-4B illustrate another embodiment of a printing, embossing and cutting board assembly, generally indicated at 400, according to the principles of the present invention. Similar to the previously illustrated embodiments, the board assembly 400 comprises a base 402, a lid 404 hingedly attached to the base 402 and a roller assembly 406 removably coupled to the base 402. In this embodiment, however, the lid 404 is coupled to be base 402 along one side 408 thereof that is generally perpendicular to the longitudinal axis of the roller assembly 406. In this exemplary embodiment, the lid 404 is hingedly attached to the base 402 in a notebook-type configuration with a pair of hinge rods 410 and 412 integrally formed with the base 402 along the side 408 and a pair of hinge rod receiving members 414 and 416 integrally formed with and extending from the side 418 of the base 404.

The base 402 is provided with a recessed surface 420 defined by perimeter walls 422 and 424. The walls 422 and 424 have a height sufficient for receiving a plurality of stamps, embossing elements or cutters and for receiving the lid 404 so that the top surface 426 of the lid 404 is substantially flush with a top surface 428 of the walls 422 and 424.

As shown in FIG. 4C, the side 408 defines a longitudinally extending groove or channel 430 along substantially the entire length thereof. A similarly configured channel is provide on the opposite side of the base 402. The hinge members 416 of the lid 404 also define a channel 432 that is coextensive with the channel 430 when the lid 404 is in a dosed position as illustrated. The roller assembly 406 is provided with a roller housing 434 for retaining the roller 436. Housing guide members 438 are provided in both ends of the roller housing 434. The housing guide members 438 include a downwardly depending guide member 440 that has an L-shaped configuration when viewed from a side thereof that includes a hook or retaining portion 442 that is substantially perpendicular to the body 444 of the guide member. A channel or slot 446 extends through the top surface of the base 402 and is sized to allow passage of the hook portion 442 of the guide member 440 for removably coupling the roller assembly 406 to the base 402. A similar slot is provided on the opposite side of the base 402 for receiving a similarly configured guide member and hook portion on the opposite end of the roller assembly 406. Thus, the roller assembly 406 can be selectively coupled to and removed from the base 402. Once the hook portions 442 are inserted through their respective slots 446 movement of the roller assembly 406 toward the opposite end of the base 402 will cause the hook portions 442 to be retained within the grooves 430. This engagement will retain the roller assembly 406 to the base 402 with the guide members 440 helping to guide the roller assembly 406 relative to the base 402 as the roller assembly 406 is moved by the user toward the opposite end of the base 402. The body 444 of the guide member 440 has a width sufficient to help prevent binding of the roller assembly 406 as it is moved relative to the base 402 by the user.

It will be appreciated that where the stamps S have a retractable portion that needs to be activated to expose the image pad, or require pressure to transfer ink from the stamp to a sheet material, a stamp layout may be formed by the placing inked stamps S in the recessed well directly over the sheet material P without adhering the stamps S to the lid 200.

Referring now to FIG. 5A, there is illustrated an apparatus, generally indicated at 500, for printing, embossing and/or cutting a sheet of paper (not shown). The multi-purpose device 500 is comprised of a first platform 502 that forms a base and a second platform 504 that forms a lid. In this embodiment of the invention, the base 502 and lid 504 are similarly configured and are joined together by hinge structures 508-510. The hinge structures 508-510 are each comprised of a generally cylindrically shaped hollow barrel portion 512 attached to a top end 514 of the base 502 and a corresponding pin 515 that is attached to the adjacent bottom end 516 of the lid 502. Each pin 515 is coupled to the lid 504 by an extending tab 518 that depends from the lid 504 with the pin 515 depending perpendicularly thereto. The length of the pin 515 and the length of the barrel portion 512 are substantially equal such that the pin 515 may just slightly protrude (as shown) or slightly be recessed within the barrel portion 512. The spacing of the pin 515 from the end 516 of the lid 504 is such that there is clearance between the barrel portion 512 and the end 516 to allow ee rotation of the lid 504 relative to the base 502. In this example where three hinge structures 508-510 are shown, the hinge structures 508-510 are spaced apart a sufficient distance to allow the lid 504 to by laterally moved relative to the base 502 to disengage each pin 515 from each barrel portion 512. Thus, the distance between each hinge structure 508-510 is at least slightly greater than the overall length of the pin 515 and the associated tab portion 518. Thus, as will be described in more detail herein, depending on whether the user is stamping, embossing or cutting, a different lid 504 can be provided to accommodate the various function to be performed. When the lid 504 is dosed relative to the base 506, the outer perimeter of the lid 504 will substantially align with the outer perimeter of the base 502. This ensures proper alignment of any element placed on the base or lid with corresponding elements placed on the lid or base, such as stamping elements, embossing elements, cutting elements or sheets of paper.

The base 502 includes a plurality of side walls 520-523 that define a recess 524 therein between. The recess 524 may have various indicia 526 printed or formed therein for indicating dimensions or relative orientation of elements placed in or upon the base. Likewise, the lid 504 includes a plurality of side walls 530-533 that define a recess 534 therein between. The recess 534 also includes various indicia 536 printed or formed therein for indicating dimensions and to assist the user in aligning various elements placed thereon relative to the base 502 or elements placed thereon.

The recesses 524 and 534 will be aligned when the lid 504 is closed upon the base 502 so that the recesses 524 and 534 are in a facing arrangement. Depending on the desired function to be performed, various inserts 540-543 can be placed in the recesses 524 and 534. For example, if the user desires to emboss a sheet of paper, slotted boards or plates 540 and 541 are placed in a respective recess 524 and 534. The slotted plates 540 and 541 are temporarily retained within each recess 524 and 534 as with a slightly tacky material, such as by applying an adhesive made for temporary attachment of paper to other objects, such as the adhesive used on sticky note paper or glue dots known in the art, or other silicon based materials that have slight adhesive properties but that can be reused multiple times to temporarily attach the slotted plates 540 and 541. Likewise, the slotted plates 540 and 541 may be temporarily secured within the recesses 524 and 534 by friction fit between the outer edges of the plates 540 and 541 and the inside surfaces of the walls 520-523 and 530-533.

Each slotted plate 540 and 541 has a plurality of laterally extending slots 540′ and 541′, respectively. The slots 540′ and 541′ are provided to receive and temporarily retain relative thereto a plurality of design elements 544 and 546. The slotted plates 540 and 541 may be formed from a transparent material such as an acrylic or polycarbonate to allow the user to view the indicia of the base 502 and the lid 504 through the slotted plates 540 and 541. The design elements 544 and 546 may each comprise a plurality of individual stamping, cutting or embossing elements depending on the function to be performed. In this example, the design elements 544 and 546 are configured and arranged to emboss a sheet of paper that is inserted between the design elements 544 and 546 when the design elements 546 are brought into engagement with the design elements 544. As such, each letter in design element 544 (which constitutes the word “DESIGN”), includes a corresponding design letter in a corresponding letter in mirror form so that when the design elements 546 are brought into engagement with the design elements 544 by dosing the lid 504 relative to the base 502. Subsequent sufficient pressing of the lid 504 relative to the base 502 will cause a sheet of paper to be embossed with the word DESIGN formed therein. It should be noted that use of the terms, “emboss,” “embossed” or “embossing” are intended herein to encompass both embossing and debossing and generally refers to a technique for imprinting a sheet of paper. Debossing is an embossing technique by which the letters or designs embossed into a sheet of paper are recessed into the sheet of paper, whereas embossing in this context would refer to a technique by which the letters or designs embossed into a sheet of paper are raised relative to the sheet of paper. Uniquely, the present invention can be used to perform both embossing and debossing simultaneously. That is, as will be described in more detail, the designs 544 and 546 can each include both embossing elements and debossing elements so long as each embossing element in one design is matched with a corresponding debossing element in the other design and vise versa.

If cutting of the design 544 into a sheet of paper is desired, such as may be desired for either creating a sheet of paper with the outline of the design in the sheet of paper or creating die cuts of the design from a sheet of paper, the design elements 544 would constitute one or more die cutters that may be attached to the slotted plate 540 and the slotted plate 540 would be placed in the recess 524. Rather than use the slotted plate 541 in the lid 504, however, a cutting mat or board 542 is inserted into the lid 504. The cutting mat or board 542 provides a surface into which the cutting elements can slightly embed to allow cutting of the paper by the cutting elements when sufficient pressure is applied between the lid 504 and base 502 with the lid 504 in a closed position relative to the base 502.

If one desires to print the design 544 on a sheet of paper, the insert 543 can be inserted into the recess 534. The insert 534 includes various indicia 550 so that the user can properly align a sheet of paper temporarily secured thereto, as with glue dots, relative to the design 544 to be applied to the sheet of paper. Once the sheet of paper is properly aligned and attached to the lid insert 543, the stamps of the design 544 can be inked. It should be noted that because the design 544 may include a plurality of stamps that are secured to the slotted plate 540, the stamps can each be inked simultaneously so that a substantially equal amount of ink is applied to each stamp for uniformity of the resulting stamped image. Once inked, the lid 504 is closed relative to the base 502 until the sheet of paper attached to the lid rests upon the stamps. Pressure can then be applied to the lid to press the paper into the stamps to transfer the ink on the stamps to the sheet of paper, thus transferring the design to the sheet of paper. Because the pressure applied to the lid is evenly distributed to the stamps through the lid, the design 544 in ink form will be uniformly distributed to the sheet of paper. Unlike hand stamping where the user must take extreme care to use consistent pressure when forming a design from multiple stamps, the device 500 of the present invention automatically causes uniform pressure distribution of the stamps of the design relative to the sheet of paper for uniform ink application.

As further illustrated in FIG. 5B, various inserts 560 and replacement lids 562 of the present invention may be used in combination with the base 502. For example, as previously discussed, for cutting or stamping, an insert 560 comprising a flat surface 561 may be inserted into the lid 504. Conversely, the recessed lid 504 may be replaced with a lid 562 that provides a uniformly flat surface to which a sheet of paper may be temporarily secured as with glue dots for stamping, with the design 544 formed from stamps attached to the slotted plate 540. The replacement lid 562 is provided with hinge pins 580-582 configured to be inserted into hinge barrels 508-510 after the lid 504 has been removed. The hinge pins 580-582 are uniformly spaced from the lid 504 and each are longitudinally aligned relative to each other to provide a single axis of rotation of the lid 504 relative to the base 502 about the plurality of hinge pins 580-582. Thus, the hinge pins 580-582 are oriented parallel to the hinge side of the lid and, when attached to their respective hinge barrels 508-510 are parallel to the hinge side of the base.

Both the base 502 and lid 504 are provided with pairs of side recesses 564 and 566 and 568 and 570, respectively. The recesses extend below the bottom surfaces 572 and 574 of the recesses 524 and 534 and to the lateral sides of the base 502 and lid 504. The recesses 564, 566, 568 and 570 thus allow a user to grip as with a finger a bottom edge of an insert, such as slotted plate 54 or insert 560 that has been inserted into one of the recesses 524 or 534, through one of the recesses 564, 566, 568 or 570 so as to remove the insert from the base 502 or lid 504.

As illustrated in FIG. 6A, an embossing set, generally indicated at 600, is comprised of an embossing element 602 and a debossing element 604. The embossing element 602 and debossing element 604 comprise a design 606 in the form of the letter “A”. The embossing element 602 is comprised of a base plate 608. The design 606 is in the form of a raised projection 610 that is uniformly spaced above the base plate 608. It should be noted, however, that some embossing designs may include embossing portions of various heights within a single design such that some portions will be raised more relative to the sheet of paper than others when formed. Extending from the bottom of the base plate 608 is a trapezoidally shaped wall 612. The wall 612 is slightly tapered from the base plate 608 to its distal side so as to be inserted and retained relative to the slotted plates 540 and 541 shown in FIG. 5A. That is, as the wall 612 is inserted into a respective slot, a sufficient friction fit is formed between the slot and the wall 612 so as to retain the embossing element 602 relative to the slotted plate. It should be noted that the walls that form the slots in the slotted plates may slightly outwardly deform when the wall 612 is inserted therein between to provide a biasing affect on the wall to maintain engagement between the wall and the slotted plate during use. As such, it may not be necessary that the wall 612 be tapered so long as the bottom edges are slightly rounded or beveled to allow easy insertion of the wall into the slot and to then cause the walls defining the slot to outwardly flex. Because the slots of the slotted plates are substantially parallel and uniformly spaced, when a user desires to provide uniform alignment between adjacent design elements, such as may be the case when forming words, any adjacently positioned or spaced embossing elements will provide uniform alignment of any resulting imprinted design, whether by embossing, debossing or printing. A recess 614 is formed on the bottom surface of the base 608 to allow for insertion of a removal tool that can be inserted into the recess 614 between the base 608 and the slotted plate so as to easily remove the embossing element 602 from the slotted plate.

A similarly configured debossing element 604 includes a base plate 620 from which a downwardly extending wall sized to be received and retained by friction fit with a slot of the slotted plate shown in FIG. 5A. The base plate 620 of the debossing element 604 is thicker than the base plate 608 of the embossing element 602 so as to define a recess 622 therein that is at least as deep as a height of the design 606 and that has a configuration that is of the same pattern as that of the design 606. The walls of the recess 622 define the design 606 but of a slightly larger size so that the design 606 can be received within the recess 622 along with a sheet of paper so as to press the paper into the recess 622 for embossing or debossing as the case may be.

As further illustrated in FIG. 6B, additional embossing and debossing elements 630 and 632 may be provided of other designs, in this case the letter. While similarly configured it is noted that each embossing and debossing element set, such as elements 630 and 632 may include multiple design features, such as the two parts of the letter “I” for simplicity purposes. Those of skill in the art will appreciate that various other more complicated designs could be provided on a single embossing and debossing element set for use with the present invention.

FIG. 7 illustrates a method of printing a design on a sheet of paper using a stamping, embossing and cutting apparatus, generally indicated at 700, in accordance with the principles of the present invention. In this embodiment, the device 700 is being used for stamping a plurality of design elements in the form of stamps 702, 704 and 706 onto a sheet of paper 708. The device 700 includes a base member 710 and a lid member 712. The base member 710 is retained relative to the lid member 712 with a hinge assembly 714. A plate 716 is provided with a plurality of apertures 718 in the form of channels or slots that extend at least partially through the plate 716 to which the design elements 702, 704 and 706. It should be noted that while described as channels or slots, the apertures 718 may comprise holes of any shape for receiving a downwardly depending base portions of each of the design elements 702, 704 and 704 that can be inserted into the apertures 718 for retaining the design elements 702, 704 and 706 relative thereto. Thus the downwardly extending portion of each design element may comprise posts, pegs or other protrusions of any shape that could be mated to a corresponding aperture for being retained by friction fit relative thereto.

The sheet of paper 708 may be temporarily attached to the lid 712 as with an adhesive layer 711 or glue dots known in the art. The lid 712 is then rotated relative to the base 710 until the paper 708 rests upon the stamps 702, 704 and 706. Because stamping requires far less pressure to be applied to the lid 712 when the base 710 is resting upon a surface, such as a table, the user may employ the use of a hand roller 722 that may be in the form of a small rolling pin to apply sufficient pressure to the lid 712, as by rolling the rolling pin 72 back and forth along the lid 712 as illustrated by arrows, so as to transfer ink applied to the stamps 702, 704 and 706 to the sheet of paper 708.

As further illustrated in FIG. 7, the hinge assembly 714 is configured to allow relative vertical movement of the pin portion 716 relative to the barrel portion 717. The barrel portion 718 includes an vertically elongated bore 720 that has a width W that is approximately equal (i.e., slight smaller) than a diameter of the pin 716 so that the pin 716 can move vertically relative to the bore 720 between a first position and a second position as shown in FIG. 7. Such allows the lid 712 to move vertically relative to the base 710 while maintaining a substantially parallel arrangement. This allows the lid to maintain even pressure distribution across the stamps 702, 704 and 706 as the stamps are compressed when pressure is applied by the roller 722. Thus, when pressure is applied by the roller 722 to the lid 712 the pin 716 will move to a compressed position, which is toward the bottom of the elongated bore 720 as illustrated. If the bore 720 were to be substantially circular so as to receive the pin 716, but not allow vertical movement of the pin 716 relative to the barrel 717, when the lid 712 is closed relative to the base 710, the sheet of paper 708 would contact the first stamp 702 and pressure would necessarily be applied by the stamp to the paper 708 before contact with stamps 704 and 706 occurred, resulting in uneven pressure distribution across the stamps 702, 704 and 707 and subsequently uneven ink deposition onto the paper 708. By allowing the pins 716 of the lid 712 to translate within the bores 720 of the barrels attached to the base 710 in a direction that is perpendicular to the surface 724 of the lid 712, the lid 712 can maintain a substantially parallel relationship with the base 710 when the lid 712 is in a closed position and maintain that substantially parallel relationship as the lid is pressed toward the base 710.

Referring now to FIG. 8A, there is illustrated a device for stamping, embossing and cutting according to the principles of the present invention, generally indicated at 800, which has been configured for simultaneously embossing and debossing so as to imprint a sheet of paper with designs provided by a plurality of sets 802, 804 and 806 of embossing elements. The embossing element set 802 is comprised of a raised embossing element 802′, having a positive relief of the design feature, and a corresponding recessed embossing element 802″, having a negative relief of the design feature. The embossing element set 804 is comprised of a raised embossing element 804′, having a positive relief of the design feature, and a corresponding recessed embossing element 804″, having a negative relief of the design feature. The embossing element set 806 is comprised of a raised embossing element 806′, having a positive relief of the design feature, and a corresponding recessed embossing element 806″, having a negative relief of the design feature. It should be noted that the illustrations of FIG. 8 (as well as the other figures herein) is not to scale in order to better illustrate the features of the present invention. Accordingly, the relative heights of the raised and recessed reliefs as well as the embossing elements themselves are enlarged to better show such features and not by way of limitation.

The base member 810 is hingedly coupled to the lid member 812 in a manner similar to that described with reference to FIG. 7 with a hinge assembly 814. The base member 810 defines a recess 816 therein for receiving a slotted plate 818 to which one part of each embossing set 802, 804 and 806 is attached. Likewise, the lid member 812 defines a recess 820 therein for receiving and retaining a slotted plate 822 that has a configuration that is a mirror image of the slotted plate 818 so that the slots of one plate 818 align with the corresponding slots of the other plate 822. That way, when the sets of embossing elements 802, 804 and 806 are positioned within respective slots, they can be caused to engage with one another as illustrated. To ensure that one part of an embossing set will align with the other, each embossing set is mated and the bottom embossing parts 802′, 804″ and 806′ are inserted in a desired slot with the other embossing parts 802″, 804′ and 806″ of each set resting on the top thereof so the raised and recessed design portions are engaged. The lid 812 is then rotated over the embossing sets 802, 804 and 806 and pressed against the embossing sets which cause the upper embossing parts 802″, 804′ and 806″ to engage a respective slot and thus be retained relative to the lid member 812. This ensures that when the lid 812 is opened and reclosed with a sheet of paper being inserted between the lid 812 and the base 810, each part of each embossing set 802, 804 and 806 will be properly aligned so that they will properly engage when the lid is forced toward the base 810 to emboss and deboss the sheet of paper.

As further illustrated in FIG. 8B, when a sheet of paper 830 is inserted between the sets of embossing elements 802, 804 and 806, the raised and recessed portions of each embossing element will be held apart by the sheet of paper 830. Accordingly, the hinge assembly 814 will having the pin portion 832 positioned proximate a top end of the elongated bore 834. The hinged folder 800 with then be ready for being pressed together as through a roller machine, generally indicated at 840 having rollers that are spaced to accommodate the hinged folder 800 and the to compress the hinged folder 800 as it passes between the rollers 842 and 844. To do so, the hinge assembly 814 is configured to have an overall height that is equal to or less than the distance D between rollers 842 and 844. As such, the hinge portion comprising the barrel 846 has a lower side surface 848 that is parallel to the bottom surface 850 of the base member 810. Likewise, the hinge portion that supports the pin 832 has a top side surface 852 that is parallel to the top surface 854 of the lid member 812. Accordingly, the entire hinged folder 800 can pass between the rollers 842 and 844 as the lid member 812 is compressed toward the base member 810 without damage to the hinge, which is further accommodated by the elongated bore hole 834 in the barrel 846 that allows translation of the hinge pin 832 relative thereto.

As further illustrated in FIG. 8C, as the hinged folder assembly 800 passes through the rollers 842 and 844 of the roller machine 840, the embossing elements of each embossing set 802, 804 and 806 are squeezed together so as to emboss (with sets 802 and 806) and deboss (with set 804) the sheet of paper 830. Correspondingly, the hinge pin 832 moves within the elongated bore hole 834 from a first position (shown in FIG. 8B) to a second position (shown in FIG. 8C) that allows the lid member 812 to move in a substantially parallel manner relative to the base member 810 as the two are pressed together to provide even distribution of force of the lid 812 relative to the base 810.

As illustrated in FIG. 9, a hinged folder assembly, generally indicated at 900, is configured similarly to the hinged folder assemblies illustrated and described with reference to FIGS. 7 and 8A. In this embodiment, the hinged folder assembly 900 is configured for cutting a sheet of paper 901 with die cutting elements, such as CED dies, 902, 904 and 906. The base member 910 defines a recess 914 within which is received a plate 916 upon which is attached a magnetic sheet 918. The magnetic sheet is provided to provide temporary attachment of the die cutters 902, 904 and 906 at specific locations as determined by a user. Thus, the user is free to position a plurality of die cutters 902, 904 and 906 at any desired location on the magnetic sheet 918 with the magnetic sheet securing by magnetic attraction the dies, which are formed of a magnetically attracted metal, such as steel. The lid member 912 is provided with a cutting mat 920 that is secured within the recess 922 to which a sheet of paper 901 to be cut is temporarily attached, as with a removable adhesive, poster putty or glue dots as are known in the art. When the hinged folder assembly 900 is run though a roller machine, generally indicated at 940, the die cutters 902, 904 and 906 cut through the paper 901 so as to form individual die cuts in the patterns of each die cutter 902, 904 and 906. While it is contemplated that a lid 912 may be used for cutting procedures such that the lid does not have recess 922 and can be replaced when other procedures, such as embossing require a different lid to which, for example, the slotted plate can be secured, the use of the insert 920, where one side is used for cutting and the other side for stamping, the same lid 912 can be used whether the user is stamping, embossing or cutting by simply replacing the insert 920 with the appropriate insert for the particular operation to be performed.

In the foregoing specification, the present invention has been described with reference to specific exemplary embodiments. Various modifications and changes may be made, however, without departing from the spirit and scope of the present invention as set forth in the claims, including without limitation combinations of various features of the various illustrated embodiments. The specification and figures are thus illustrative, not restrictive, and modifications and combinations are intended to be included within the scope of the present invention. Accordingly, the scope of the present invention should be determined by the claims and their legal equivalents rather than by the examples described.

For example, the steps recited in any method or process claims may be executed in any order and are not limited to the specific order presented in the claims. Additionally, the components and/or elements recited in any apparatus claims may be assembled or otherwise operationally configured in a variety of permutations and are accordingly not limited to the specific configuration recited in the claims.

Benefits, other advantages, and solutions to problems have been described above with regard to particular embodiments. Any benefit, advantage, solution to problem, or any element that may cause any particular benefit, advantage, or solution to occur or to become more pronounced are not to be construed as critical, required, or essential features or components of any or all the claims.

The terms “comprise”, “comprises”, “comprising”, “having”, “including”, “includes” or any variations of such terms, are intended to reference a non-exclusive inclusion, such that a process, method, article, composition or apparatus that comprises a list of elements does not include only those elements recited, but may also include other elements not expressly listed or inherent to such process, method, article, composition or apparatus. Other combinations and/or modifications of the above-described structures, arrangements, applications, proportions, elements, materials, or components used in the practice of the present invention, in addition to those not specifically recited, may be varied or otherwise particularly adapted to specific environments, manufacturing specifications, design parameters, or other operating requirements without departing from the general principles of the same.

What is claimed is:

1. A hinged folder assembly, comprising:
a base with a planar upper surface having a recessed well surrounded by a plurality of sidewalls and a hinge side;
a lid for placing over the recessed well at least partially extending over and between the plurality of sidewalls, the lid being hingedly attached to the base along the hinge side of the base and a hinge side of the lid; and
a first insert sized to be received and retained within the recessed well temporarily retained within said recessed well, the first insert formed from a plate having a plurality of apertures formed therein;
at least one first design element secured to said first insert by at least being partially inserted into a least one of the plurality of apertures, the design element comprising one of a stamp, an embossing element and a die cutter.

2. The hinged folder assembly of claim 1, further comprising a hinge assembly comprised of a plurality of hinge barrels attached to the hinge side of the base and a plurality of hinge pins, each inserted into a respective one of the plurality of barrel portions, each hinge barrel defining an elongated bore therethrough having a width that is substantially equal to a diameter of a respective hinge pin and a height that is greater than the diameter of the respective hinge pin to allow relative movement of the hinge pin relative to the hinge barrel and thus movement between the lid and the base while maintaining a substantially parallel relationship between the lid and the base.

3. The hinged folder assembly of claim wherein the plurality of apertures of the first insert comprise a plurality of uniformly spaced slots extending across the insert from proximate one side to proximate an opposite side and the at least one design element comprises a base portion having a design element disposed on a top side thereof and a retaining portion depending from a bottom side of the base portion for insertion into one of the plurality of uniformly spaced slots to temporarily retain the base portion relative to the first insert by friction fit between the retaining portion and the one of the plurality of uniformly spaced slots.

4. The hinged folder assembly of claim 2, wherein the plurality, of hinge barrels having a lower surface that is substantially parallel with a bottom surface of the base and an upper surface that does not extend above a top surface of the lid when the lid is in a closed and compressed position relative to the base to allow passage of the hinge barrel through a roller machine.

5. The hinged folder assembly of claim 4, wherein the plurality of hinge pins are attached to the lid with a plurality of extending tabs depending from the hinge side of the lid, the plurality of hinge pins each perpendicularly depending from a respective one of the plurality of extending tabs and each of the plurality of hinge pins being longitudinally aligned relative to each other.

6. The hinged folder assembly of claim 4, wherein the at least one design element comprises one of a stamp and a die cutter.

7. The hinged folder assembly of claim 4, wherein the lid defines a recessed well therein and further comprising a second insert sized to be received and temporarily retained within the recessed well of the lid, the second insert formed from a plate having a plurality of apertures formed therein.

8. The hinged folder assembly of claim 7, further comprising at least one wherein the at least one second design element secured to said second insert and aligned relative to the at least one first design element so as to engage the at least one first design element when the lid is closed relative to the base.

9. The hinged folder assembly of claim 8, wherein the at least one first design element comprise a positive embossing element and the at least one second design element comprises a negative embossing element for engaging with the at least one first design element to emboss an image provided by engagement of the at least one first and second design elements.

10. The hinged folder assembly of claim 9, wherein the at least one first and second design elements comprise a plurality of sets of embossing elements and wherein at least some of the sets of embossing elements are positioned between the lid and the base for embossing a sheet of paper and at least some of the sets of embossing elements are positioned between the lid and the base for simultaneously debossing the sheet of paper.

11. A method of printing, embossing or cutting, comprising:
providing a hinged folder assembly, comprising:
a base having a recessed surface defined by a plurality of sidewalls and a hinge side;
a lid hingedly coupled to the base having a recessed surface defined by a plurality of side ails and configured to be rotated about a hinge assembly relative to the base for placing the recessed surface of the lid over the recessed surface of the base;
a first insert sized to be received and temporarily retained within the recess of the base;
a second insert sized to be received and temporarily retained with the recess of the lid;
a hinge assembly comprised of a plurality of hinge barrels attached to the base and a corresponding plurality of hinge pins attached to the lid for engaging with the plurality of hinge barrels to hingedly attach the lid to the base, the plurality of hinge barrels each defining an elongated, non-circular bore therethrough having a width that is substantially equal to a diameter of a respective hinge pin and a height that is greater than the diameter of the respective hinge pin to allow relative vertical movement of the hinge pin relative to the hinge barrel while restricting horizontal movement of the hinge pin relative to the bore, thus allowing movement between the lid and the base while maintaining a substantially parallel relationship between the lid and the base when the lid is in a closed position;
inserting the first insert into the base;
inserting the second insert into the lid;
providing a first design element and temporarily attaching the first design element to the insert of the base;
placing a sheet of paper between the lid and the base;
dosing the lid relative to the base so that the lid overlays the base;
applying pressure to the top surface of the lid of sufficient force to cause the first design element to press against the sheet of paper to transfer a first design on the first design element to the sheet of paper;
opening the lid relative to the base; and
removing the sheet of paper having the design transferred from the first design element from between the lid and the base.

12. The method of claim 11, further comprising providing the first insert with a plurality of apertures formed therein and providing the first design dement with a protrusion extending from a bottom surface thereof for engaging with a least one of the plurality of apertures for temporarily retaining the first design element relative to the base.

13. The method of claim 12, further comprising providing the first insert with a plurality of uniformly spaced slots extending across the first insert from proximate one side to proximate an opposite side and further comprising providing a second design element having a different design from the first design element and temporarily attaching the second design element to the first insert.

14. The method of claim 13, further comprising retaining the first and second design elements in a same slot so as to align the first and second design elements relative to each other.

15. The method of claim 14, further comprising providing the second insert with a plurality of uniformly spaced slots extending across the second insert from proximate one side to proximate an opposite side so that when the lid is placed above the base, the plurality of uniformly spaced slots of the first insert align with the plurality of uniformly spaced slots of the second insert.

16. The method of claim 14, further comprising providing the first design element in the form of a first embossing set and further comprising providing the second design element in the form of a second embossing set.

17. The method of claim 16, further comprising orienting the first embossing set between the lid and the base so as to emboss the sheet of paper and orienting the second embossing set between the lid and the base so as to deboss the sheet of paper to simultaneously emboss and deboss the sheet of paper.

18. The method of claim 1, wherein applying pressure comprises running the hinged folder assembly completely through a roper press.

19. The method of claim 18, wherein running the hinged folder assembly through a roller press causes the hinge plurality of hinge pins to vertically translate relative to the plurality of hinge barrels to allow relative movement of the lid relative to the base as pressure is applied to the lid and the base.

20. The method of claim 1, further comprising providing the first design element in the form of a die cutter, providing the second insert in the form of a cutting mat and forming at least one die cut from a sheet of paper inserted between the die cutter and the cutting mat.

21. The method of claim 1, further comprising providing the first design element in the form of a stamp, providing the second insert in the form of a flat surface, applying ink to the stamp and printing the design of the design element on the sheet of paper.
